(19) United States
(12) Patent Application Publication
(10) Pub. No.: US 2006/0171099 A1
(43) Pub. Date: Aug. 3, 2006

(54) Electrode paste for thin nickel electrodes in multilayer ceramic capacitors and finished capacitor containing same

(76) Inventors: Daniel E. Barber, Greenville, SC (US); Ian Burn, Hockessin, DE (US); James J. Beeson, Simpsonville, SC (US); Azizuddin Tajuddin, Laurens, SC (US)

Correspondence Address: Joseph T. Guy, Ph.D.;Nexsen Pruet, LLC, Post Office Box 10107, Greenville, SC, 29603, US

(21) Appl. No.: 11/359,075

(22) Filed: Feb. 22, 2006

Related U.S. Application Data
(62) Division of application No. 11/052,715, filed on Jan. 31, 2005.

(51) Int. Cl. H01G 4/06

(52) U.S. Cl. 361/321.2

(57) ABSTRACT

A method for forming a capacitor and capacitor formed thereby. The method comprises a) forming a capacitor precursor with green ceramic layers separated by conductive precursor layers wherein the conductive precursor layers have 30-80 wt % nickel precursor; up to 20 wt % grain growth inhibitor and 20-70 wt % organic vehicle; and b) heating the capacitor precursor to convert the green ceramic layers to ceramic dielectric layers and the conductive precursor layers to conductive layers.

### CROSS-REFERENCE TO RELATED APPLICATIONS

The present application is a divisional application of U.S. pat. appl. Ser. No. 11/052,705 which is pending.

### BACKGROUND OF THE INVENTION

The present invention is related to a ceramic capacitor comprising thin nickel electrodes. More particularly the present invention is related to a ceramic capacitor comprising thin nickel electrodes with grain growth inhibitors incorporated therein.

The technology for production of multi-layer ceramic capacitors (MLC's) with Ni electrodes has advanced rapidly in the last 5 years such that capacitors with dielectric layers as thin as 1 micrometer are now possible. Such technology is well described by Wada et al. in U.S. Pat. No. 6,303,529 issued in 2001. However, the technology for the production of MLC's usually involves printing an electrode paste containing Ni powder onto dielectric tape and then laminating a stack of metal and ceramic layers before dicing them into individual pieces and fusing them by firing in an atmosphere of low oxygen content at temperatures near 1250° C. While it is now possible to cast ceramic tape to a thickness of 1 micrometer, or less, it has not been possible to reduce the thickness of the Ni electrode layer much below 1 micrometer. This is because, in spite of advances in screen printing technology, the electrode layers lose their continuity when small amounts of electrode paste are used. Also, the thickness of the electrode tends to increase during firing due to growth of the Ni grains as they sinter. This problem is illustrated very well on page 9 in the publication “Ultra-fine barium titanate for multilayer ceramic capacitors” by Y. Sakabe, I. Nakamura and N. Wada, in Ceramic Transactions Vol. 112, pp, 3-10, 2001.

The inability to reduce the electrode thickness results in two main problems: firstly, it adds unwanted thickness to the capacitor and makes miniaturization more difficult, and secondly, it causes distortion of the electrode/dielectric stack after lamination, leading to potential defects and decreased reliability in use. This latter problem is described by Tokuoka et al. in U.S. Pat. No. 6,550,117 issued in 2003, who suggest a method of flattening the stack in the margin areas using a thermal transfer technique for printing the electrode, and to insert additional dielectric. However, the electrode thickness is not substantially reduced by this approach. In addition, Sano et al, in U.S. Pat. No. 6,143,109, issued in 2000, suggest a method for reducing the electrode thickness by using thin-film techniques such as vapor deposition, sputtering, or plating but these technologies are difficult or costly to use.

In Journal of the Ceramic Society of Japan, Vol. 112 (8), 458-461 (2004), Ueyama et al. discuss the need to reduce the thickness of Ni electrode layers in multilayer ceramic capacitors. To achieve this objective they prepared electrode pastes containing very fine Ni powders (0.2 or 0.4 μm particle size) and found that sintering of the Ni particles could be inhibited by adding approximately 1 wt % of a barium titanate resinate to the paste. The barium titanate resinate was expected to coat the Ni particles in the paste and decompose to a barium titanate film during firing. The authors suggest that the use of a barium titanate resinate is more effective than adding barium titanate powder, as used in earlier work, because the available barium titanate powders are not fine enough to fit within the triple points of the sintered Ni grains. They noted that the additive reduced the rate of shrinkage of the Ni films during firing and that growth of Ni crystals in the film was retarded. However, there is no indication in this work that the use of nickel oxide or nickel carbonate instead of fine Ni powder will lead to thin electrodes. Also, there is no suggestion that other additives might work as well, or better, than barium titanate resinate in suppressing growth of Ni grains during sintering.

Nakatani et al. in U.S. Pat. No. 4,863,683 and U.S. Pat. No. 4,714,570 describes a method of manufacturing a multilayer ceramic substrate with base metal conductors in which the conductors are formed by using a paste containing CuO, NiO, CoO, or Fe₂O₃ as the main component. The oxides are reduced to the metallic state by heat-treatment in an atmosphere of H₂ +N₂. The purpose of using the oxides is to permit an initial heat-treatment in air to remove much of the organic binder from the multilayer ceramic body. Adhesion of the metal conductors to the ceramic body is not adequate unless the conductor paste also contains at least one bonding agent selected from Bi₂O₃, CdO, MnO₂, and Al₂O₃. A glass powder can also be added to the paste to improve adhesion of the conductor to the ceramic body. Such bonding agents are either deleterious or ineffective in producing thin conductors, as required by the present invention.

Nishimura et al in JA-03-112860 and U.S. Pat. No. 5,014,158 describe multilayer ceramic capacitors with Ni electrodes that are constructed by using a conductor paste containing NiO. The stated purpose for using NiO instead of Ni is to improve the elimination of organic components powder from the multilayer ceramic capacitor during firing because an initial firing stage in air can be used. Such a heat treatment in air can lead to oxidation and expansion of the electrodes when Ni powder is the main component of the electrode paste. This oxidation and expansion can result in cracking of the dielectric body or delaminations of the dielectric layers. The thickness of the Ni layers in the fired capacitors was 3-4 μm and there is no teaching on how to reduce the electrode thickness to less than 1 μm. In particular, there is no teaching in the invention by Nishimura et al of the use of additives to the NiO or electrode paste to control growth of the Ni grains when the NiO decomposes to Ni and sinters during the firing process.

A process is described in EP 0 797 225 A2 wherein a multilayer ceramic capacitor is made with an electrode paste consisting mainly of NiO and fired in air to form a dense monolith, e.g. at 1320° C. The sintered multilayer, still containing layers of NiO, was then re-fired (e.g. at 1300° C.) in an atmosphere of low oxygen content to convert the NiO to conducting layers of Ni. The novelty of this invention is that the multilayer is initially fired to full density in air before the NiO is converted to Ni metal. The advantages do not include the ability to produce thin Ni electrodes. Also, there is no teaching on how to control grain growth in the sintered Ni layers by modifying the NiO or electrode paste with additives. Furthermore, such a process is not likely to be applicable to multilayer ceramic capacitors with electrodes <1 μm because NiO will diffuse into the dielectric, and continuity of the layers will be lost, if the heating temperature in air is close to the sintering temperature of the dielectric.

Consequently, it is the objective of the invention to provide a means of manufacturing MLC's with Ni electrodes in which the electrodes are produced by screen printing and are less than 1 micrometer in thickness after firing.

### SUMMARY OF THE INVENTION

It is an object of the present invention to provide a method for manufacturing a capacitor, and capacitor manufactured thereby, with thin conductors.

It is another object of the present invention to provide a method for manufacturing a capacitor, and capacitor manufactured thereby, wherein conductive precursor layers can be coated at a thickness sufficient to facilitate coating yet which, upon heating, form continuous thin conductive layers.

A particular feature of the present invention is the ability to form thin conductive layers without loss of conductivity typically realized in such constructions.

These and other advantages, as will be realized, are provided in a method for forming a capacitor. The method comprises a) forming a capacitor precursor with green ceramic layers separated by conductive precursor layers wherein the conductive precursor layers have 30-79.99 wt % nickel precursor; 0.01-20 wt % grain growth inhibitor and 20-69.99 wt % organic vehicle; and b) heating the capacitor precursor to convert the green ceramic layers to ceramic dielectric layers and the conductive precursor layers to conductive layers.

Yet another embodiment is provided in a method for forming a capacitor. The method comprises:
a) forming a capacitor precursor with dielectric green layers separated by conductive precursor layers wherein the conductive precursor layers have 50-90 wt % NiCO₃, 1-5 wt % organic binder and 9-49 wt % organic vehicle; and
b) heating said capacitor precursor to convert said dielectric green layers to dielectric and said conductive precursor layers to conductive layers.

Yet another embodiment is provided in a method for forming a capacitor. The method includes the steps of:
a) forming a capacitor precursor with dielectric green layers separated by conductive precursor layers wherein the conductive precursor layers have 30-79.99 wt % nickel oxide; 0.01-20 wt % grain growth inhibitor and 20-69.99 wt % organic vehicle; and
b) heating the capacitor precursor to convert the dielectric green layers to dielectric and the conductive precursor layers to conductive layers.

Yet another embodiment is provided in a method for forming a capacitor. The method includes:
a) forming a capacitor precursor with dielectric green layers separated by conductive precursor layers wherein the conductive precursor layers have 30-79.99 wt % nickel carbonate; 0.01-20 wt % grain growth inhibitor and 20-69.99 wt % organic vehicle; and
b) heating the capacitor precursor to convert the dielectric green layers to dielectric and the conductive precursor layers to conductive layers.

A particularly preferred embodiment is provided in a method for forming a capacitor. The method includes:
a) forming a capacitor precursor with dielectric green layers separated by conductive precursor layers wherein the conductive precursor layers are 0.7 to 1.5 μm thick and comprise 30-79.99 wt % of a nickel precursor selected from nickel oxide and nickel carbonate; 0.01-20 wt % grain growth inhibitor selected from rare-earth or alkaline-earth oxide, tungsten oxide, molybdenum oxide, chromium oxide, tantalum oxide, niobium oxide and zirconium oxide or precursors thereof and 20-69.99 wt % organic vehicle; and
b) heating the capacitor precursor to convert the dielectric green layers to dielectric and the conductive precursor layers to conductive layers thereby forming a capacitor envelope.

Yet another embodiment is provided in a capacitor. The capacitor has parallel conductive plates with dielectric there between. The parallel conductive plates comprise nickel and at least one element selected from rare earth, alkaline earth, yttrium, tungsten, tantalum, molybdenum, chromium, niobium and zirconium. A first external termination is in electrical contact with first alternating conductive plates of the parallel conductive plates. A second external termination is in electrical contact with second alternating conductive plates of the parallel conductive plates.

### BRIEF DESCRIPTION OF THE DRAWINGS

FIG. 1 illustrates a cross-sectional view of a capacitor of the present invention.

### DETAILED DESCRIPTION OF THE INVENTION

The invention is directed to an electrode paste composition in which a powder of nickel oxide (NiO), nickel carbonate (NiCO₃), or combinations thereof is used as the main ingredient. When the paste is used to make MLC's, the nickel oxide or nickel carbonate powder is reduced to Ni metal and sinters to become a metallic conductor. The combination of the lower density of NiO and its decomposition to Ni results in a reduction in the volume of the electrode print of about 40.7%. For NiCO₃, the reduction in volume is about 75.6%. In addition, it has been found that certain additives, when mixed with the NiO or NiCO₃ as a fine powder, or added as a coating or metal-organic compound or liquid, are very effective in suppressing growth of the Ni grains in the fired electrode films.

The present invention will be described with reference to the figure forming an integral part of the instant disclosure.

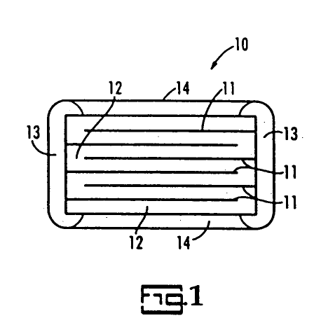

A cross-sectional view of a capacitor of the present invention is illustrated schematically in FIG. 1. In FIG. 1, the capacitor, generally represented at 10, comprises a multiplicity of conductive layers, 11, of nickel alloy with ceramic, 12, dispersed there between. Alternating layers of the conductive layer terminate at opposing external terminals, 13, of opposite polarity.

The electrode paste comprises 30-79 wt % of a nickel precursor preferably selected from NiO or NiCO₃ powder; up to about 20 wt % grain growth inhibitor; 1-5 wt % of organic binder such as ethyl cellulose, acrylic or polystyrene polymers and the like. The balance of the paste, referred to herein as organic vehicle, includes solvents; such as mineral spirits, terpineol, butyl carbitol acetate, and the like; polymeric dispersant typically employed at about 0.1 to 1.0 wt %; sintering inhibitors, such as barium titanate and other adjuvants as known in the art.

The grain growth inhibitor is preferably added to the paste in an amount of about 0.01 to 20 wt %. Below about 0.01 wt % grain growth inhibitor the effect is minimal. Above about 20 wt% the conductivity decreases in the conductive layer which is undesirable. More preferably, the grain growth inhibitor is added in an amount of about 0.1 to 10 wt % and more preferably about 0.1 to 5 wt %. Most preferably, the grain growth inhibitor is added in an amount of less than 5 wt %.

The maximum particle size of the nickel precursor powder, or Dₘₐₓ, is preferably less than about 0.75 μm in diameter. Above about 0.75 μm defects can be created in the ceramic sheet or thicker areas can be created in the electrode, both of which can lead to electrical shorts. More preferably, the maximum particle size of the nickel precursor powder, or Dₘₐₓ, is less than about 0.6 μm and even more preferably less than about 0.5 μm. Particle size measurement is well known in the art and can be done with scanning electron microscope or laser light scattering techniques. It is typical to report particle size as a maximum (Dₘₐₓ), a minimum (Dₘᵢₙ) and a median diameter (D₅₀). For the purposes of the present invention it is most preferred that the particle size be uniform with a median diameter, D₅₀, of 0.1 to 0.5 μm. Below a D₅₀ of about 0.1 μm the particles become difficult to disperse. It is more preferred that the particles have a D₅₀ of less than about 0.4 μm and even more preferably less than about 0.2 μm.

The conductive layer, after firing, comprises nickel and about 0.1-40 wt % of the reduced grain growth inhibitor. More preferably, the conductive layer, after firing, comprises nickel and about 0.2-15 wt % of the reduced grain growth inhibitor. Most preferably, the conductive layer, after firing, comprises nickel and less than 10 wt % of the reduced grain growth inhibitor.

While not limited to any theory, it is hypothesized that the grain growth inhibitors preclude, or retard, Ostwald ripening thereby encouraging new particle formation and a lower average particle size. The lower average particle size is preferable to achieve continuity at lower layer thicknesses.

It is preferred that the grain growth inhibitors are selected from oxides of rare earths, alkaline earths, yttrium, tungsten, tantalum, molybdenum, chromium, niobium, zirconium or precursors, and combinations thereof. The preferred grain growth inhibitors are selected from oxides of a group consisting of lanthanum, cerium, praseodymium, neodymium, samarium, europium, gadolinium, terbium, dysprosium, holmium, erbium, thulium, ytterbium, lutetium, magnesium, calcium, strontium, barium, yttrium, tungsten, tantalum, molybdenum, chromium, niobium and zirconium. More preferably the grain growth inhibitors are selected from oxides of a group consisting of lanthanum, cerium, praseodymium, neodymium, samarium, gadolinium, dysprosium, holmium, erbium, ytterbium, lutetium, calcium, strontium, barium, yttrium, tungsten, tantalum, molybdenum, chromium, niobium and zirconium. Most preferably the grain growth inhibitors are selected from oxides of a group consisting of yttrium, tungsten, tantalum, molybdenum, chromium, niobium and zirconium.

In a particularly preferred embodiment the electrode paste comprises about 50-90 wt % nickel carbonate, about 1-5 wt % binder with the balance being organic vehicle.

The thickness of the conductive layers, prior to firing, is preferably below about 1.5 μm. More preferably the thickness of the conductive layers, prior to firing, is below about 1 μm. Most preferably the thickness of the conductive layers, prior to firing, is below about 0.9 μm with about 0.7 μm being optimal. A particular advantage of the present invention is the ability to coat a layer at a thickness which is easily applied under manufacturing conditions and, after firing, the thickness is less while still maintaining adequate conductivity. After firing the thickness is preferably below about 1 μm. More preferably the thickness after firing is below about 0.7 μm. Most preferably the thickness after firing is below about 0.5 μm.

The ceramic is not particularly limiting herein. The material for the ceramic, for example, may be made of BaTiO₃ and other dielectric materials, insulators, magnetic materials and semiconductor materials or combinations thereof as known in the art.

The dielectric layers may have any desired mean grain size. By limiting the dielectric material to the above-defined composition, there are obtained fine crystal grains which typically have a mean grain size of about 0.2 to 0.7 μm.

The dielectric layers have an appropriate Curie temperature which is determined in accordance with the applicable standards by suitably selecting a particular composition of dielectric material. Typically the Curie temperature is higher than 45° C., especially about 65° C. to 125° C.

Each dielectric layer preferably has a thickness of up to about 50 μm, more preferably up to about 20 μm. The lower limit of thickness is about 0.5 μm, most preferably about 1 μm. The present invention is effectively applicable to multilayer ceramic chip capacitors having such thin dielectric layers for minimizing a change of their capacitance with time. The number of dielectric layers stacked is generally from 2 to about 1,000, preferably from 2 to about 600.

The multilayer ceramic chip capacitor of the present invention generally is fabricated by forming a green chip by conventional printing and sheeting methods using pastes, firing the chip, and printing or transferring external electrodes thereto followed by baking.

Paste for forming the dielectric layers can be obtained by mixing a raw dielectric material with an organic vehicle. The raw dielectric material may be a mixture of oxides and composite oxides as previously mentioned. Also useful are various compounds which convert to such oxides and composite oxides upon firing. These include, for example, carbonates, oxalates, nitrates, hydroxides, and organometallic compounds. The dielectric material is obtained by selecting appropriate species from these oxides and compounds and mixing them. The proportion of such compounds in the raw dielectric material is determined such that after firing, the specific dielectric layer composition may be met. The raw dielectric material is generally used in powder form having a mean particle size of about 0.1 to about 2 μm, preferably below about 1 μm.

The organic vehicle includes an organic solvent, dispersants, sintering inhibitors and other adjuvants as known in the art.

The binder used herein is not critical and may be suitably selected from conventional binders such as ethyl cellulose. Also the organic solvent used herein is not critical and may be suitably selected from conventional organic solvents such as terpineol, butylcarbinol, acetone, and toluene in accordance with a particular application method such as a printing or sheeting method.

Paste for forming external electrodes is prepared by the same method as the internal electrodes layer-forming paste. Grain growth inhibitors need not be included in the external electrodes.

No particular limit is imposed on the organic vehicle content of the respective pastes mentioned above. If desired, the respective pastes may contain any other additives such as dispersants, plasticizers, dielectric compounds, and insulating compounds. The total content of these additives is preferably up to about 10 wt %.

A green chip then may be prepared from the dielectric layer-forming paste and the internal electrode layer-forming paste. In the case of printing method, a green chip is prepared by alternately printing the pastes onto a substrate of polyethylene terephthalate (PET), for example, in laminar form, cutting the laminar stack to a predetermined shape and separating it from the substrate.

Also useful is a sheeting method wherein a green chip is prepared by forming green sheets from the dielectric layer-forming paste, printing the internal electrode layer-forming paste on the respective green sheets, and stacking the printed green sheets.

The binder is then removed from the green chip and fired. Binder removal may be carried out under conventional conditions, preferably under the following conditions where the internal electrode layers are formed of a base metal conductor such as nickel and nickel alloys.

The heating rate is preferably about 5 to 300° C./hour, more preferably 10 to 100° C./hour. The holding temperature is preferably about 200 to 400° C., more preferably 250 to 300° C. The holding time is preferably about ½ to 24 hours, more preferably 5 to 20 hours. The atmosphere is preferably air. The green chip is then fired in an atmosphere with an oxygen partial pressure of 10⁻⁸ to 10⁻¹² atm. Extremely low oxygen partial pressure should be avoided, since at such low pressures the conductor can be abnormally sintered and may become disconnected from the dielectric layers. At oxygen partial pressures above the range, the internal electrode layers are likely to be oxidized.

For firing, the chip preferably is held at a temperature of 1,100° C. to 1,400° C., more preferably 1,150 to 1,250° C. Lower holding temperatures below the range can provide insufficient densification whereas higher holding temperatures above the range can lead to poor DC bias performance. Remaining conditions for preferred sintering are as typically employed. The heating rate is preferably about 50 to 500° C./hour, more preferably 200 to 300° C./hour. The holding time is preferably about ½ to 8 hours, more preferably 1 to 3 hours. The cooling rate is preferably about 50 to 500° C./hour, more preferably 200 to 300° C./hour. The firing atmosphere preferably is a reducing atmosphere. An exemplary atmospheric gas is a humidified mixture of N₂ and H₂ gases.

Firing of the capacitor chip in a reducing atmosphere preferably is followed by annealing. Annealing is effective for re-oxidizing the dielectric layers, thereby optimizing the resistance of the ceramic to dielectric breakdown. The annealing atmosphere may have an oxygen partial pressure of at least 10⁻⁶ atm., preferably 10⁻⁵ to 10⁻⁴ atm. The dielectric layers are not sufficiently re-oxidized at low oxygen partial pressures below the range, whereas the internal electrode layers are likely to be oxidized at oxygen partial pressures above this range.

For annealing, the chip preferably is held at a temperature of lower than 1,100° C., more preferably 500° C. to 1,000° C. Lower holding temperatures below the range would oxidize the dielectric layers to a lesser extent, thereby leading to a shorter life. Higher holding temperatures above the range can cause the internal electrode layers to be oxidized (leading to a reduced capacitance) and to react with the dielectric material (leading to a shorter life). Annealing can be accomplished simply by heating and cooling. In this case, the holding temperature is equal to the highest temperature on heating and the holding time is zero.

Remaining conditions for annealing preferably are as follows. The holding time is preferably about 0 to 20 hours, more preferably 6 to 10 hours. The cooling rate is preferably about 50 to 500° C./hour, more preferably 100 to 300° C./hour.

The preferred atmospheric gas for annealing is humid nitrogen gas. The nitrogen gas or a gas mixture used in binder removal, firing, and annealing, may be humidified using a wetter. In this regard, water temperature preferably is about 5 to 75° C.

The binder removal, firing, and annealing may be carried out either continuously or separately. If done continuously, the process includes the steps of binder removal, changing only the atmosphere without cooling, raising the temperature to the firing temperature, holding the chip at that temperature for firing, lowering the temperature to the annealing temperature, changing the atmosphere at that temperature, and annealing.

If done separately, after binder removal and cooling down, the temperature of the chip is raised to the binder-removing temperature in dry or humid nitrogen gas. The atmosphere then is changed to a reducing one, and the temperature is further raised for firing. Thereafter, the temperature is lowered to the annealing temperature and the atmosphere is again changed to dry or humid nitrogen gas, and cooling is continued. Alternately, once cooled down, the temperature may be raised to the annealing temperature in a nitrogen gas atmosphere. The entire annealing step may be done in a humid nitrogen gas atmosphere.

The resulting chip may be polished at end faces by barrel tumbling and sand blasting, for example, before the external electrode-forming paste is printed or transferred and baked to form external electrodes. Firing of the external electrode-forming paste may be carried out under the following conditions: a humid mixture of nitrogen and hydrogen gases, about 600 to 800° C., and about 10 minutes to about 1 hour.

Pads are preferably formed on the external electrodes by plating or other methods known in the art.

External terminations are applied by any method known in the art. Each external termination preferably is in electrical contact with alternating conductive layers as described previously.

The capacitor may be encased in resin, except for the pads, by any method known in the art.

The multilayer ceramic chip capacitors of the invention can be mounted on printed circuit boards, for example, by soldering.

An example of a suitable electrode paste would be prepared as follows: 59 wt % nickel oxide having a mean particle diameter of 0.5 micron and 10 wt % ceramic having a mean particle diameter of 0.1 micron would be milled with 20 wt % solvent and 1 wt % dispersant to achieve a well-dispersed slurry. A solution of ethyl cellulose binder in solvent would be added such that the amount of binder would be 2.5% and the final amount of solvent would be 26%. To this ink, 1.5 wt % chromium oxide as a liquid resinate with 2-ethylhexanoic acid would be added and thoroughly mixed. The final ink would be screen printed in a suitable electrode pattern onto a green dielectric sheet, sheets would be stacked and laminated, and the resulting green composites would be singulated to obtain individual green capacitors. Green capacitors would be baked out, fired, and terminated by standard processes. The resulting fired MLC's would have dielectric thickness of 1.0 micron and electrode thickness of approximately 0.7 micron, with electrode continuity of 85% or higher.

The present invention has been described with particular reference to the preferred embodiments without limit. It would be apparent to one of skill in the art, based on the description herein, that alternate embodiments could be envisioned without departing from the scope of the invention which is specifically set forth in the claims appended hereto.

1-16. (canceled)

17. A capacitor manufactured by the method
forming a capacitor precursor comprising green ceramic layers separated by conductive precursor layers wherein said conductive precursor layers comprise 30-79.99 wt % nickel precursor; 0.01-20 wt % grain growth inhibitor and 20-69.99 wt % organic vehicle; and
heating said capacitor precursor to convert said green ceramic layers to ceramic dielectric layers and said conductive precursor layers to conductive layers.

18. A capacitor comprising:
parallel conductive plates with dielectric there between wherein said parallel conductive plates comprise nickel and at least one element selected from rare earth, alkaline earth, yttrium tungsten, tantalum, molybdenum, chromium, niobium and zirconium;
a first external termination in electrical contact with first alternating conductive plates of said parallel conductive plates; and
a second external termination in electrical contact with second alternating conductive plates of said parallel conductive plates.

19. The capacitor of claim 18 wherein said parallel conductive plates are no more than 1 μm thick.

20. The capacitor of claim 19 wherein said parallel conductive plates are no more than 0.7 μm thick.

21. The capacitor of claim 20 wherein said parallel conductive plates are no more than 0.5 μm thick.

22. The capacitor of claim 20 wherein said element comprises at least one of lanthanum, cerium, praseodymium, neodymium, samarium, europium, gadolinium, terbium, dysprosium, holmium, erbium, thulium, ytterbium, lutetium, magnesium, calcium, strontium, barium, yttrium, tungsten, tantalum, molybdenum, chromium, niobium and zirconium.

23. The capacitor of claim 22 wherein said element comprises at least one of lanthanum, cerium, praseodymium, neodymium, samarium, gadolinium, dysprosium, holmium, erbium, ytterbium, lutetium, calcium, strontium, barium, yttrium, tungsten, tantalum, molybdenum, chromium, niobium and zirconium.

24. The capacitor of claim 23 wherein said element comprises at least one of yttrium, tungsten, tantalum, molybdenum, chromium, niobium and zirconium.

25. The capacitor of claim 18 wherein said conductive plates comprise 60-99.8 wt % nickel and 0.1-40 wt % of said element.

26. The capacitor of claim 25 wherein said conductive plates comprise 0.1-10 wt % of said element.

27. The capacitor of claim 26 wherein said conductive plates comprise 0.1-5 wt % of said element.

28-45. (canceled)

46. A capacitor formed by the method of:
forming a capacitor precursor comprising dielectric green layers separated by conductive precursor layers wherein said conductive precursor layers comprise 30-90 wt % NiCO₃ and 1-5 wt % organic binder and 9-69 wt % organic vehicle: and
heating said capacitor precursor to convert said dielectric green layers to dielectric and said conductive precursor layers to conductive layers.

47-55. (canceled)

56. A capacitor formed by the method of:
forming a capacitor precursor comprising dielectric green layers separated by conductive precursor layers wherein said conductive precursor layers are 0.7 to 1.5 μm thick and comprise 30-79.99 wt % of a nickel precursor selected from nickel oxide and nickel carbonate; 0.01-20 wt % grain growth inhibitor selected from rare-earth or alkaline-earth oxide, tungsten oxide, tantalum oxide, molybdenum oxide, chromium oxide, niobium oxide and zirconium oxide or precursor thereof and 20-69.99 wt % organic vehicle: and
heating said capacitor precursor to convert said dielectric green layers to dielectric and said conductive precursor layers to conductive layers thereby forming a capacitor envelope.
